(19) United States
(12) Patent Application Publication
(10) Pub. No.: US 2005/0065789 A1
(43) Pub. Date: Mar. 24, 2005

(54) System and method with automated speech recognition engines

(76) Inventors: Sherif Yacoub, Sant Cugat del Valles (ES); Steven J. Simske, Fort Collins, CO (US); Xiaofan Lin, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/668,121

(22) Filed: Sep. 23, 2003

(51) Int. Cl. G10L 15/00

(52) U.S. Cl. 704/231

(57) ABSTRACT

A system comprises a computer system having a central processing unit coupled to a memory and extraction algorithm. A plurality of different automatic speech recognition (ASR) engines are coupled to the computer system that is adapted to analyze a speech utterance and select one of the ASR engines that will most accurately recognize the speech utterance.

### BACKGROUND

Automated speech recognition (ASR) engines enable people to communicate with computers. Computers implementing ASR technology can recognize speech and then perform tasks without the use of additional human intervention.

ASR engines are used in many facets of technology. One application of ASR occurs in telephone networks. These networks enable people to communicate over the telephone without operator assistance. Such tasks as dialing a phone number or selecting menu options can be performed with simple voice commands.

ASR engines have two important goals. First, the engine must accurately recognize the spoken words. Second, the engine must quickly respond to the spoken words to perform the specific function being requested. In a telephone network, for example, the ASR engine has to recognize the particular speech of a caller and then provide the caller with the requested information.

Systems and networks that utilize a single ASR engine are challenged to recognize accurately and consistently various speech patterns and utterances. A telephone network, for example, must be able to recognize and decipher between an inordinate number of different dialects, accents, utterances, tones, voice commands, and even noise patterns, just to name a few examples. When the network does not accurately recognize the speech of a customer, processing errors occur. These errors can lead to many disadvantages, such as unsatisfied customers, dissemination of misinformation, and increased use of human operators or customer service personnel.

### SUMMARY

In one embodiment in accordance with the invention, a method of automatic speech recognition (ASR) comprises providing a plurality of categories for different speech utterances; assigning a different ASR engine to each category; receiving a first speech utterance from a first user; classifying the first speech utterance into one of the categories; and selecting the ASR engine assigned to the category to which the first speech utterance is classified to automatically recognize the first speech utterance.

In another embodiment, an automatic speech recognition (ASR) system comprises: means for processing a digital input signal from an utterance of a user; means for extracting information from the input signal; and means for selecting a best performing ASR engine from a group of different ASR engines to recognize the utterance of the user, wherein the means for selecting a best performing ASR engine utilizes the extracted information to select the best performing ASR engine.

Other embodiments and variations of these embodiments are shown and taught in the accompanying drawings and detailed description.

### BRIEF DESCRIPTION OF THE DRAWINGS

FIG. 1 is a block diagram of an example system in accordance with an embodiment of the present invention.

FIG. 2 illustrates an automatic speech recognition (ASR) engine.

FIG. 3 illustrates a flow diagram of a method in accordance with an embodiment of the present invention.

FIG. 4 illustrates another flow diagram of a method in accordance with an embodiment of the present invention.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

Embodiments in accordance with the present invention are directed to automatic speech recognition (ASR) systems and methods. These embodiments may be utilized with various systems and apparatus that use ASR. FIG. 1 illustrates one such exemplary embodiment.

FIG. 1 illustrates a communication network 10. Network 10 may be any one of various communication networks that utilize ASR. For illustration, a voice telephone system is described. Network 10 generally comprises a plurality of switching service points (SSP) 20 and telecommunication pathways 30A, 30B that communicate with communication devices 40A, 40B. The SSP may, for example, form part of a private or public telephone communication network. FIG. 1 illustrates a single switching service point, but a private or public telephone communication network can comprise a multitude of interconnected SSPs.

The SSP 20 can be any one of various configurations known in the art, such as a distributed control local digital switch or a distributed control analog or digital switch, such as an ISDN switching system.

The network 10 is in electronic communication with a multitude of communication devices, such as communication device-1 (shown as 40A) to communication device-Nth (shown as 40B). As one example, the SSP 20 could connect to one communication device via a land-connection. In another example, the SSP could connect to a communication device via a mobile or cellular type connection. Many other types of connections (such as internet, radio, and microphone interface connections) are also possible.

Communication devices 40 may have many embodiments. For example, device 40B could be a land phone, and device 40A could be a cellular phone. Alternative, these devices could be any other electronic device adapted to communicate with the SSP or an ASR engine. Such devices would comprise, for example, a personal computer, a microphone, a public telephone, a kiosk, or a personal digital assistant (PDA) with telecommunication capabilities.

The communication devices are in communication with the SSP 20 and a host computer system 50. Incoming speech is sent from the communication device 40 to the network 10. The communication device transforms the speech into electrical signals and converts these signals into digital data or input signals. This digital data is sent through the host computer system 50 to one of a plurality of ASR systems or engines 60A, 60, 60C, wherein each ASR system 60 is different (as described below). As shown, a multitude of different ASR systems can be used with the present invention, such as ASR system-1 to ASR system-Nth.

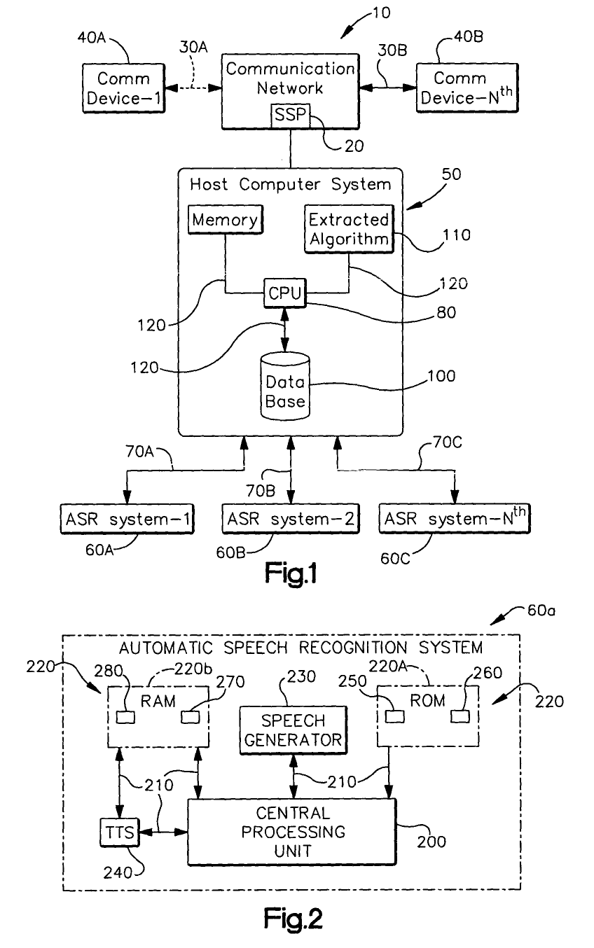

The ASR systems (described in detail in FIG. 2 below) are in communication with host computer system 50 via data buses 70A, 70R, 70C host computer system 50 comprise a central processing unit (CPU) 80 for controlling the overall operation of the computer, memory 90 (such as random access memory (RAM) for temporary data storage and read only memory (ROM) for permanent data storage), a non-volatile data base for storing control programs and other data associated with host computer system 100, and an extraction algorithm 110. The CPU communicates with memory 90, data base 100, extraction algorithm 110, and many other components via buses 120.

FIG. 1 shows a simplified block diagram of a voice telephone system. As such, the host computer system 50 would be connected to a multitude of other devices and would include, by way of example, input/output (I/O) interfaces to provide a flow of data from local area networks (LAN), supplemental data bases, and data service networks, all connected via telecommunication lines and links.

FIG. 2 shows a simplified block diagram of an exemplary embodiment of an ASR system 60A that can be utilized with embodiments of the present invention. Since various ASR systems are known, FIG. 2 illustrates one possible system. The ASR system could be adapted for use with either speaker-independent or speaker-dependent speech recognition techniques. The ASR system generally comprises a CPU 200 for controlling the overall operation of the system. The CPU has numerous data buses 210, memory 220 (including ROM 220A and RAM 220B), speech generator unit 230 for communicating with participants, and a text-to-speech (TTS) system 240. System 240 may be adapted to transcribe written text into a phoneme transcription, as is known in the art.

As shown in FIG. 2, memory 220 connects to CPU and provides temporary storage of speech data, such as words spoken by a participant or caller from communication devices 40. The memory can also provide permanent storage of speech recognition and verification data that includes a speech recognition algorithm and models of phonemes. In this exemplary embodiment, a phoneme based speech recognition algorithm could be utilized, although many other useful approaches to speech recognition are known in the art. The system may also include speaker dependent templates and speaker independent templates.

A phoneme is a term of art that refers to one of a set of smallest units of speech that can be combined with other such units to form larger speech segments, example morphemes. For example, the phonetic segments of a single spoken word can be represented by a combination of phonemes. Models of phonemes can be compiled using speech recognition class data that is derived from the utterances of a sample of speakers belonging to specific categories or classes. During the compilation process, words selected so as to represent all phonemes of the language are spoken by a large number of different speakers.

In one type of ASR system, the written text of a word is received by a text-to-speech unit, such as TTS system 240, so the system can create a phoneme transcription of the written text using rules of text-to-speech conversion. The phoneme transcription of the written text is then compared with the phonemes derived from the operation of a speech recognition algorithm 250. The speech recognition algorithm, in turn, compares the utterances with the models of phonemes 260. The models of phonemes can be adjusted during this “model training” process until an adequate match is obtained between the phoneme derived from the text-to-speech transcription of the utterances and the phonemes recognized by the speech recognition algorithm 250.

Models of phonemes 260 are used in conjunction with speech recognition algorithm 250 during the recognition process. More particularly, speech recognition algorithm 250 matches a spoken word with established phoneme models. If the speech recognition algorithm determines that there is a match (i.e. if the spoken utterance statistically matches the phoneme models in accordance with predefined parameters), a list of phonemes is generated.

Embodiments in accordance with the present invention are adapted to use either or both speaker independent recognition techniques or speaker dependent recognition techniques. Speaker independent techniques can comprise a template 270 that is a list of phonemes representing an expected utterance or phrase. The speaker independent template 216, for example, can be created by processing written text through TTS system 240 to generate a list of phonemes that exemplify the expected pronunciations of the written word or phrase. In general, multiple templates are stored in memory 220 to be available to speech recognition algorithm 250. The task of algorithm 250 is to choose which template most closely matches the phonemes in a spoken utterance.

Speaker dependent techniques can comprise a template 280 that is generated by having a speaker provide an utterance of a word or phrase, and processing the utterance using speech recognition algorithm 250 and models of phonemes 260 to produce a list of phonemes that comprises the phonemes recognized by the algorithm. This list of phonemes is speaker dependent template 280 for that particular utterance.

During real time speech recognition operations, an utterance is processed by speech recognition algorithm 250 using models of phonemes 260 such that a list of phonemes is generated. This list of phonemes is matched against the list provided by speaker independent templates 270 and speaker dependent templates 280. Speech recognition algorithm 250 reports results of the match.

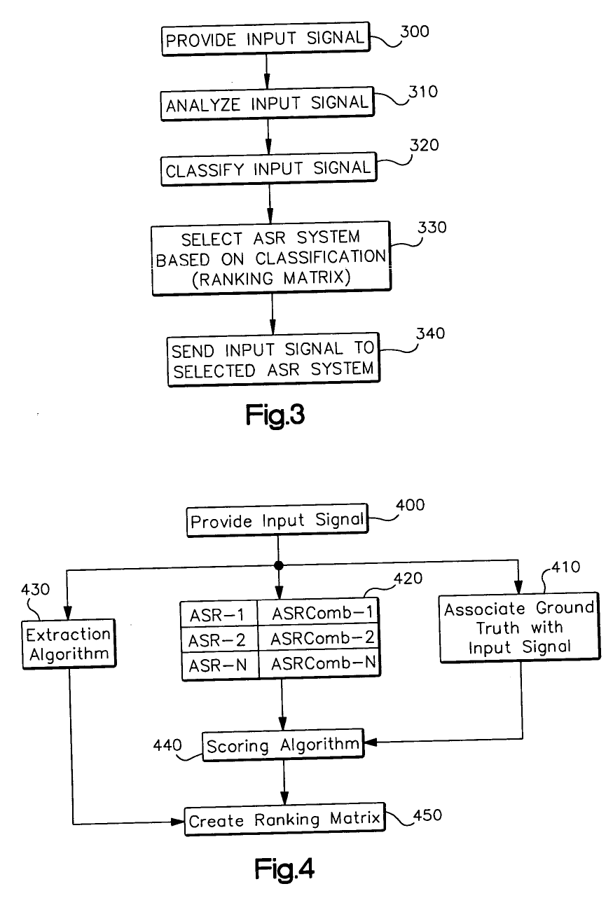

FIG. 3 is a flow diagram describing the actions of a communication network or system when the system is operating in a speaker independent mode. As an example of one embodiment of the present invention, the method is described in connection with FIG. 1. Assume that a participant (such as a telephone caller) telephones or otherwise establishes communication between communication device 40 and communication network 10. Per block 300, the communication device provides SSP 20 with an electronic input signal in a digital format.

Per block 310, the host computer 50 analyzes the input signal. During this phase, the input signal is processed using feature and property extraction algorithm 110. As discussed in more detail below, the features and properties extracted from the input signal are matched against features and properties of a plurality of stored categories, and the signal is assigned to the best matching category.

Per block 320, the host computer system 50 classifies the input signal and assigns it a designated or selected category. The computer system then looks up the selected category in a ranking matrix or table stored in memory 90.

Per block 330, the host computer system 50 selects the best ASR system 60 based on the selected category and comparison with the ranking matrix. The best ASR system 60 suitable for the specific category of input signal is selected from a plurality of different systems 60A-60Nth. In other words, a specific ASR system is selected that has the best performance or best accuracy (example, the least Word Error Rate (WER)) for the particular type of input signal (i.e., particular type of utterance of the participant).

Per block 340, the input signal is sent to the selected ASR system (or combination of ASR systems). The ASR engine recognizes the input signal or speech utterance.

Systems that utilize a single ASR engine (with predefined configuration and number or service ports) are not likely to provide accurate automatic voice recognition for a wide variety of different speech utterances. A telephone communication system that utilizes only one ASR engine is likely to perform adequately for some input signals (i.e., speech utterances) and poorly for other input signals.

Embodiments in accordance with the present invention provide a system that utilizes multiple ASR engine types. Each ASR engine works particularly well (example, high accuracy) for a specific type of input signal (i.e., specific characteristics or properties of the input speech signal). During operation, the system analyzes the input signal and determines the germane properties and features of the input data. The overall analysis includes classifying input signal and evaluating this classification against a known or determined ranking matrix. The system automatically selects the best ASR engine to use based on the specific properties and features extracted from the input signal. In other words, the best performing ASR engine is selected from a group of different ASR engines. This best performing ASR engine is selected to correspond to the particular type of input data (i.e., particular type of utterance or speech). As a result, the overall accuracy of the system of the present invention is much better than a system that utilizes a single ASR engine or selects from a single ASR engine. Moreover, the system of the present invention can utilize a combination of ASR engines for utterances that are difficult to recognize by one single ASR engine. Hence, the system offers the best utilization of different ASR engines (such as ASR engines available from different licensees) to achieve a highest possible accuracy of all of the ASR engines available to the system.

The system thus utilizes a method to intelligently select an ASR engine from a multiplicity of ASR engines at runtime. The system has the ability to implement a dynamic selection method. In other words, the selection of a particular ASR engine or combination of ASR engines is selected to meet particular speech types. As an example, a first speech type might be best suited for ASR engine 60A. A second speech type might be best suited for ASR engine 60B. A third speech type might be best suited for ASR system 60C (a combination of two ASR engines). As such, the system is dynamic since it changes or adapts to meet the particular needs or requirements of a specific utterance. Best suited or best results means that the output of the ASR engine has historically proven to be most accurately correlated with the correct data.

Preferably, a determination is made as to which ASR engine or system is best for a specific type of speech signal. Further, a determination can be made as to how to classify the speech signal so the proper ASR system is selected based on the ranking matrix.

Given a plurality of ASR engine types, some engines may perform better than others for specific types of speech signals. To get this assessment, some statistical analysis can be conducted. To determine which ASR works best on specific types of speech signals, the category (or subset) to which a speech signal belongs can be determined. This determination can be made using a training set to obtain classification categories, using the training set to rank the available ASR engines based on these categori ground truth data is used as input to the statistical analysis phase. The output of this phase is a data structure that can be saved in memory as a ranking matrix or table.

Table 1 illustrates an example of a ranking matrix in which gender is used as the classifier. By a “category” we mean a category of speech signal. There are several characteristics and properties in the input speech that can be used to define categories. For example, some properties could be related to the nature of the signal itself like the noise level, power, pitch, duration (length), etc. Other properties could be related characteristics of the speech or speaker, such as gender, age, accent, tone, pitch, name, or input data, to list a few examples. These characteristics and properties are extracted from the input signal using feature extraction algorithms. Thus, any sub-categorization of the overall domain of ASR engines is covered by this invention. Properties such as, but not limited to, those described above are used to predictively select a particular ASR engine or particularly tune an ASR engine for more accurate performance.

The invention is not limited to a particular type of characteristics or properties. Instead, the description only illustrates the use of gender as an example. Embodiments in accordance with the invention also can use other characteristics and properties or a combination of characteristics and properties to define categories. For instance, a combination of gender and noise level decibel range can define a category. As another example, gender and age could define a category. In short, any single or combination of characteristics or properties can be used to define a single category or multiple categories. This disclosure will not attempt to list or define all such categories since the range is so vast.

Further yet, categories can be defined or developed using various statistical analysis techniques. As one example, decision trees or principle component analysis on ground-truth sample data could be used to obtain categories. Various other statistical techniques are known in the art and could be utilized to develop categories for embodiments in accordance with the present invention.

It is also possible to tune or adjust an ASR engine to perform best for a particular category of input signals. For example, an ASR engine can be tuned to recognize male utterances with higher accuracy. The same engine can be tuned to perform better for female utterances. In such cases, the invention deals with each instance of a tuned engine as a separate ASR engine.

Accuracy of an ASR engine (or combination of engines) in recognizing the speech signal can be one factor used to develop the ranking matrix. Other factors, as well, can be used. For example, cost can be used as a factor to develop the ranking matrix. Different costs (such as the cost of a particular ASR engine license or the cost of utilizing multiple ASR engines versus a single engine) can also be considered. As another example, time can be used as a factor to develop the ranking matrix. For example, the time required for a particular ASR engine or group of engines to recognize a particular speech signal could be factors. Of course, numerous other factors can be utilized as well with embodiments in accordance with the present invention.

The following description uses accuracy of the ASR engines as a prime factor in developing the ranking matrix. Here, accuracy is measured in terms of the correct recognition rate (or the complement of the word error rate). Further, the term “ranking” means the relative order of ASR engine or engines that produce output highly correlated with the ground truth data. In other words, ranking defines which ASR engine or combination of engines has the best accuracy for a particular category. As noted, other criteria or factors can be used for ranking. As another factor beside accuracy, response time (also referred to as performance of the engine in real time applications) can be used. The ranking method can be a cost function that is a combination of several factors, such as accuracy and response time.

With accuracy as the main criteria then, Table 1 illustrates an example of a ranking matrix using gender as the classifier. Column 1 (entitled “Speech Signal Category”) is divided into three different categories: male, female, and child. Column 2 (entitled “Ranking”) shows various ASR engines and combination of engines used in the statistical analysis phase.

TABLE 1
The Ranking Matrix

| Speech Signal | |
|---|---|
| Category | Ranking |
| Male | ASR1 |
| | 2-engine combination (ASR1, ASR2) |
| | Sequential Try Combination (ASR1, ASR2, ASR5) |
| | 3-engine Vote (ASR1, ASR2, ASR5) |
| | ASR2 |
| | ASR5 |
| | ASR3 |
| | ASR4 |
| Female | 2-engine combination (ASR1, ASR2) |
| | Sequential Try Combination (ASR1, ASR2, ASR5) |
| | 3-engine Vote (ASR1, ASR2, ASR5) |
| | ASR1 |
| | ASR2 |
| | ASR5 |
| | ASR3 |
| | ASR4 |
| Child | 2-engine combination (ASR1, ASR2) |
| | ASR1 |
| | 3-engine Vote (ASR1, ASR2, ASR5) |
| | Sequential Try Combination (ASR1, ASR2, ASR5) |
| | ASR2 |
| | ASR5 |
| | ASR3 |
| | ASR4 |

The abbreviations in the second column (example, ASR1, ASR2, etc.) represent a key that is used to identify an ASR engine or a combination of them. By way of example only, ASR1 engine could be a Speechworks engine; ASR2 could be the Nuance engine; ASR3 could be the Sphinx engine from Carnegie Mellon University; ASR4 could be a Microsoft engine; and ASR5 could be the Summit engine from Massachusetts Institute of Technology. Of course, other commercially available ASR engines could be utilized as well. Further yet, embodiments of the present invention are not limited to assessing individual ASR engines; various embodiments can also use combinations of ASR engines. The combination of engines could, for example implement some combination schemas like voting schema or confusion-matrix-based 2-engines combination.

Male, Female, and Child illustrate one type of category, but embodiments of the invention are not so limited. As an example, “Low Frequency/Middle Frequency/High Frequency” or “Distinct Words/Slightly Adjoined Words/Slurred Words” could be used as the speech signal categorization. Categorization can be used as a predictive means for minimizing WER, but other means for minimizing WER are also possible. For example, a comparison could be done of a first categorization to any other categorization for an overall ability to reduce WER. In such a case, several categories can be tested and the effectiveness of the categorization criterion or a combination of criteria can be measured against the overall WER reduction.

FIG. 4 illustrates a flow diagram for creating a ranking matrix in accordance with one embodiment of the present invention. Once the ranking matrix is created, it can be used with various systems and methods employing ASR technology. As one example, the ranking matrix can be used with network 10 (FIG. 1), stored in memory 90, and utilized with extraction algorithm 110.

Per block 400, an input signal (such as a speech utterance) is provided. Sample speech utterances may be obtained from off-the-shelf databases. As alternative, data can be obtained from the real application by recording some user or participant interactions with an ASR engine.

Per block 410, ground truths are associated with the input signal. Preferably, the correct or exact text corresponding to the input signal is specified in advance. Again, off-the-shelf databases can be used to obtain this information. Ground truth tools can also be used in which the user types the correct text corresponding to each input signal into a keyboard connected to a computer system employing the appropriate software

Per block 420, a plurality of ASR engines and systems are provided. Embodiments of the present invention can also use a combination of two or more ASR engines to appear as one virtual engine. The speech signals can be processed by different ASR engines (ASR1, ASR2, ASR3, . . . ASR-Nth) or by competing combinations of different ASR engines (ASR Comb 1, ASR Comb 2, ASR Comb3, . . . ASR Comb-Nth). As noted above, these ASR engines can be selected from a variety of different engines or systems.

Per block 430, the input signal is provided to an extraction algorithm. The speech utterances can be processed using a combination of feature extraction algorithms. The output will be characteristics, properties, and features of each input utterance.

Per block 440, results from blocks 420 and 410 are sent to a scoring algorithm. Here, a specified function can be used to assess the output from each ASR engine. As noted above, the function could be accuracy, time, cost, other function, or combinations of functions. The output from each ASR is assessed or compared to the ground truth data using a scoring matrix to determine scores (or correlation factors) for each input signal or speech utterance.

Per block 450, output from the scoring algorithm and extraction algorithm create the ranking matrix or table. A statistical analysis procedure can be used, for example, to automatically generate categories based on the input signal properties and features and the corresponding scores. ASR engines are then ranked according to their performance (relevant to the specified function) in the defined categories.

Methods and systems in accordance with some embodiments of the present invention were utilized to obtain trial data. The following data illustrates just one example implementation of the present invention.

For this illustration, the following criteria were used:

1) gender as the classifier to establish categories as male, female, or child;

2) five ASR engines and three combination schemas to represent eight possible ASR systems;

3) a speech corpus DB with ˜45,000 words in ˜12,000 utterances; and

4) accuracy (in terms of Word Error Rate, WER) as the scoring function.

Tables 2-5 illustrate the results. Using gender as a classifier, the data illustrates that for a male, engine ASR1 is best performer. For a female and child (boy or girl), the combination scheme ASRComb1 is the best performer.

This example embodiment illustrates distinct improvement over a single ASR engine. The improvement can be summarized as follows: a 3% improvement for boys, 30% for women, and 6% for girls. Further, the example embodiment had a WER of 2.257%. The best engine performance (ASR1) is 2.439%. Therefore, the example embodiment achieved a 7.5% relative improvement.

TABLE 2
Comparing WER for Male Testing Corpus

| Category | Male | | | | | | | |
|---|---|---|---|---|---|---|---|---|
| # Words | 14159 | | | | | | | |
| ASR Engine | ASR1 | ASR2 | ASR3 | ASR4 | ASR5 | ASR | ASR | ASR |
| | | | | | | Comb1 | Comb2 | Comb3 |
| Substitutions | 25 | 45 | 93 | 134 | 65 | 20 | 21 | 17 |
| Deletions | 25 | 57 | 37 | 258 | 100 | 16 | 49 | 38 |
| Insertions | 7 | 20 | 79 | 2772 | 20 | 23 | 8 | 4 |
| Word Error | 0.402 | 0.86 | 1.48 | 22.35 | 1.31 | 0.416 | 0.55 | 0.42 |
| Rate (%) | | | | | | | | |

TABLE 3
Comparing WER for Female Testing Corpus

| Category | Female | | | | | | | |
|---|---|---|---|---|---|---|---|---|
| # Words | 14424 | | | | | | | |
| ASR Engine | ASR1 | ASR2 | ASR3 | ASR4 | ASR5 | ASR | ASR | ASR |
| | | | | | | Comb1 | Comb2 | Comb3 |
| Substitutions | 46 | 107 | 336 | 457 | 180 | 22 | 43 | 34 |
| Deletions | 26 | 66 | 46 | 857 | 83 | 17 | 35 | 26 |
| Insertions | 14 | 9 | 177 | 2634 | 17 | 20 | 5 | 5 |
| Word Error | 0.6 | 1.26 | 3.88 | 27.37 | 1.94 | 0.41 | 0.58 | 0.45 |
| Rate (%) | | | | | | | | |

TABLE 4
Comparing WER for Boy Testing Corpus

| Category | Boy | | | | | | | |
|---|---|---|---|---|---|---|---|---|
| # Words | 6325 | | | | | | | |
| ASR Engine | ASR1 | ASR2 | ASR3 | ASR4 | ASR5 | ASR | ASR | ASR |
| | | | | | | Comb1 | Comb2 | Comb3 |
| Substitutions | 151 | 316 | 709 | 541 | 480 | 127 | 193 | 194 |
| Deletions | 83 | 86 | 81 | 694 | 106 | 35 | 47 | 46 |
| Insertions | 50 | 84 | 290 | 1087 | 66 | 112 | 56 | 59 |
| Word Error | 4.49 | 7.69 | 17.07 | 36.75 | 10.3 | 4.34 | 4.69 | 4.73 |
| Rate (%) | | | | | | | | |

TABLE 5
Comparing WER for Girl Testing Corpus

| Category | Girl | | | | | | | |
|---|---|---|---|---|---|---|---|---|
| # Words | 6312 | | | | | | | |
| ASR Engine | ASR1 | ASR2 | ASR3 | ASR4 | ASR5 | ASR | ASR | ASR |
| | | | | | | Comb1 | Comb2 | Comb3 |
| Substitutions | 289 | 649 | 1333 | 719 | 842 | 264 | 408 | 397 |
| Deletions | 220 | 207 | 230 | 1098 | 305 | 115 | 135 | 139 |
| Insertions | 67 | 147 | 489 | 975 | 102 | 161 | 106 | 106 |
| Word Error | 9.13 | 15.89 | 32.5 | 44.23 | 19.8 | 8.56 | 10.3 | 10.2 |
| Rate (%) | | | | | | | | |

The example embodiment could, for example, be utilized with the network 10 of FIG. 1. Here, the input signal (i.e., speech utterance from the communication device 40) would be sent to SSP 20 and to host computer system 50. The extraction algorithm 110 would analyze the input signal to determine an appropriate category. In other words, the extraction algorithm 110 would determine if the speech utterance was from a male, a female, or a child. The host computer system 50 would then select the best ASR system for the input signal. If the speech utterance were from a male, the ASR1 (shown for example as ASR System-1 at 60A) would be utilized. If the speech utterance were from a female or child, then ASR Comb1 (shown for example as one of ASR System Nth at 60C) would be used.

The application operation profile (usage profile) can be used to optimize the deployment of the ASR engines. In the example using the example data with FIG. 1, for example, assume for some telephony-based network a 40%, 40%, 10%, 10% caller distributions among male, female, boys, and girls, respectively, is established. Then ASR1 will be used 40% of the times and the two-engine combination scheme ASR Comb1 will be used 60% of the times. Hence the telephone service provider could distribute the number of ports to purchase as follows: 40% licenses of ASR1 and 60% for ASR Comb1.

The method and system in accordance with embodiments of the present invention may be utilized, for example, in hardware, software, or combination. The software implementation may be manifested as instructions, for example, encoded on a program storage medium that, when executed by a computer, perform some particular embodiment of the method and system in accordance with embodiments of the present invention. The program storage medium may be optical, such as an optical disk, or magnetic, such as a floppy disk, or other medium. The software implementation may also be manifested as a program computing device, such as a server programmed to perform some particular embodiment of the method and system in accordance with the present invention.

While the invention has been disclosed with respect to a limited number of embodiments, those skilled in the art will appreciate numerous modifications and variations therefrom. It is intended that the appended claims cover such modifications and variations as fall within the true spirit and scope of the invention.

1. A method of automatic speech recognition (ASR), comprising:
providing a plurality of categories for different speech utterances;
assigning a different ASR engine to each category;
receiving a first speech utterance from a first user;
classifying the first speech utterance into one of the categories; and
selecting the ASR engine assigned to the category to which the first speech utterance is classified to automatically recognize the first speech utterance.

2. The method of claim 1 wherein providing a plurality of categories for different speech utterances further comprises providing a male category and a female category.

3. The method of claim 1 wherein assigning a different ASR engine to each category further comprises assessing accuracy of each ASR engine for each category.

4. The method of claim 3 wherein assessing accuracy of each ASR engine for each category further comprises determining a least Word Error Rate of each ASR engine for each category.

5. The method of claim I wherein assigning a different ASR engine to each category further comprises assessing time required for each ASR engine to recognize speech utterances.

6. The method of claim 1 further comprising:
receiving a second speech utterance from a second user;
classifying the second speech utterance into one of the categories; and
selecting the ASR engine assigned to the category to which the second speech utterance is classified to automatically recognize the speech utterance, wherein the ASR engine assigned to the category to which the second speech utterance is classified is different from the ASR engine assigned to the category to which the first speech utterance is classified.

7. The method of claim 6 wherein the first speech utterance is classified into a male category, and the second speech utterance is classified into a female category.

8. An automatic speech recognition (ASR) system comprising:
means for processing a digital input signal from an utterance of a user;
means for extracting information from the input signal; and
means for selecting a best performing ASR engine from a group of different ASR engines to recognize the utterance of the user, wherein the means for selecting a best performing ASR engine utilizes the extracted information to select the best performing ASR engine.

9. The ASR system of claim 8 further comprising means for storing a ranking matrix, the ranking matrix comprising a plurality of different categories of speech signals and a plurality of different ASR engine rankings corresponding to the plurality of different categories.

10. The system of claim 9 wherein the different categories are selected from the group consisting of gender, noise level, and pitch.

11. The system of claim 9 wherein the different ASR engines comprise single ASR engines and multiple ASR engines combined together.

12. The system of 9 wherein the plurality of different ASR engine rankings are derived from statistical analysis.

13. The system of claim 12 wherein the statistical analysis comprises assessing accuracy of speech recognition of different ASR engines with different speech signals.

14. A system, comprising:
a computer system having a central processing unit coupled to a memory and extraction algorithm; and
a plurality of different automatic speech recognition (ASR) engines coupled to the computer system, wherein the computer system is adapted to analyze a speech utterance and select one of the ASR engines that will most accurately recognize the speech utterance.

15. The system of claim 14 wherein the extraction algorithm extracts data from the speech utterance to classify the speech utterance into a category selected from the group consisting of male and female.

16. The system of claim 14 wherein the computer system selects the ASR engine that has the least word error rate for the speech utterance.

17. The system of claim 14 further comprising at least three different ASR engines and at least three different combination schemas of ASR engines to represent a total of at least six different ASR engines.

18. The system of claim 14 further comprising a telephone network comprising at least one switching service point coupled to the computer system.

19. The system of claim 18 further comprising at least one communication device in communication with the switching service point to provide the speech utterance.

20. The system of claim 14 wherein the memory comprises a ranking table with a plurality of different categories of speech signals and a plurality of different ASR engine rankings corresponding to the plurality of different catego
